(19) United States
(12) Patent Application Publication
(10) Pub. No.: US 2011/0321020 A1
(43) Pub. Date: Dec. 29, 2011

(54) TRANSFORMING DECLARATIVE EVENT RULES INTO EXECUTABLE PROCEDURES

(75) Inventors: Francis G. McCabe, Cupertino, CA (US); Kenneth R. MacKenzie, Boulder Creek, CA (US)

(73) Assignee: STARVIEW TECHNOLOGY, INC., San Jose, CA (US)

(21) Appl. No.: 12/821,991

(22) Filed: Jun. 23, 2010

(51) Int. Cl. G06F 9/45; G06F 17/30

(52) U.S. Cl. 717/144; 707/797; 707/E17.087; 707/E17.012

(57) ABSTRACT

In an embodiment of the present invention, event handlers are used to trigger actions based on events occurring on a data stream. A process of the present invention involves creating the event handler, which may be embodied in, for example, software. The creation of the event handler involves parsing all of the rules in a manner that allows events themselves to trigger actions that will ultimately involve evaluation of rule and, if necessary, firing of those rules.

### BACKGROUND OF THE INVENTION

1. Field of the Invention

The present invention relates to the field of computer software. More particularly, the present invention relates to the transformation of declarative event rules into executable procedures.

2. Description of the Related Art

Event stream processing (ESP) is a set of technologies designed to assist the construction of event-driven information systems. In event-driven information systems, events occurring inside or outside a computer system are monitored and actions are taken in response to the occurrence of various events. ESP technologies include event visualization, event databases, event-driven middleware, and event processing languages, or complex event processing (CEP). ESP deals with the task of processing multiple streams of event data with the goal of identifying the meaningful events within those streams, employing techniques such as detection of complex patterns of many events, event correlation and abstraction, event hierarchies, and relationships between events such as causality, membership, and timing, and event-driven processes.

Typically, events are handled by a series of defined rules. These rules may be built into an application or may be created by a user. A typical event rule syntax may be as follows:
on event₁ and event₂ or event₃ and no event₄ do action.

Thus, the event rules may essentially be a series of if . . . then . . . else type rules. There are several issues with this type of syntax, however, when it is used in an event processing system.

First of all, the cost (in processing power) of a set of rules is the sum of the individual rules. In an event processing system, these rules may be firing constantly, resulting in a significant decrease in the cost of a set of rules if there was some way to reduce the processing cost even slightly. Second of all, in an event processing system, events may not arrive in any given particular order. In the example rule above, for example, event₄ could be received before event₁. Thus, time may be wasted as the processor may need to wait to process the portion of the rule that evaluates event₄ until event₁ is detected. This not only can delay execution, but also limits the processor's ability to schedule rule evaluations in an efficient manner.

As such, what is needed is a more efficient mechanism for event processing.

### SUMMARY OF THE INVENTION

In a first embodiment of the present invention, a method for compiling a rule is provided, the method comprising: receiving the rule, wherein the rule comprises one or more patterns and one or more actions, wherein each of the patterns comprise one or more leaf patterns and one or more operators, wherein each of the leaf patterns reference one or more variables; creating an abstract syntax tree for the rule, wherein the abstract syntax tree contains a head internal node having the one or more patterns as one child and the one or more actions as another child, wherein the one or more patterns are expressed as a sub-tree having the one or more operators as internal nodes and the one or more leaf patterns as leaf nodes; creating an output alpha table for each node of the pattern sub-tree, wherein the output alpha table for a particular node also represents a left or right input alpha table of the particular node's parent, wherein for every leaf node the output alpha table contains entries for each variable to which the leaf node references, for every internal node representing a comparison or “not” operator, the output alpha table contains no entries, for every internal node representing an “and” operator, the output alpha table contains all entries from both left and right input alpha tables for the node, and for every internal node representing an “or” operator, the alpha table contains only entries that are contained in both the left and right input alpha tables for the node; and creating a data structure containing a listing, for each event, of each node that references the event.

In a second embodiment of the present invention, a method for handling an event is provided, comprising: retrieving an abstract syntax tree associated with a rule containing the event, wherein the abstract syntax tree contains a head internal node having one or more patterns as one child and one or more actions as another child, wherein the one or more patterns are expressed as a sub-tree having the one or more operators as internal nodes and the one or more leaf patterns as leaf nodes; for any leaf patterns that match the event: storing values for each variable referenced by the leaf pattern in an output alpha table; and recursively: passing the output alpha table to a parent node; if the parent node has input alpha tables with enough stored values to evaluate an operator associated with the parent node: evaluating the parent node; storing values from the input alpha tables in a parent output alpha table; and passing the parent output alpha table up to a next parent.

In a third embodiment of the present invention, a compiler is provided comprising: a rule receiver; an abstract syntax tree creator coupled to the rule receiver and to a memory; an output alpha table creator coupled to the abstract syntax tree creator and to the memory; and a listing data structure creator coupled to the rule receiver.

In a fourth embodiment of the present invention, an apparatus is provided comprising: an abstract syntax tree retriever; a memory coupled to the abstract syntax tree retriever; an alpha table storer coupled to the memory; a node evaluator coupled to the memory; and an alpha table passer coupled to the memory.

In a fifth embodiment of the present invention, an apparatus for compiling a rule is provided, the apparatus comprising: means for receiving the rule, wherein the rule comprises one or more patterns and one or more actions, wherein each of the patterns comprise one or more leaf patterns and one or more operators, wherein each of the leaf patterns reference one or more variables; means for creating an abstract syntax tree for the rule, wherein the abstract syntax tree contains a head internal node having the one or more patterns as one child and the one or more actions as another child, wherein the one or more patterns are expressed as a sub-tree having the one or more operators as internal nodes and the one or more leaf patterns as leaf nodes; means for creating an output alpha table for each node of the pattern sub-tree, wherein the output alpha table for a particular node also represents a left or right input alpha table of the particular node's parent, wherein for every leaf node the output alpha table contains entries for each variable to which the leaf node references, for every internal node representing a comparison or “not” operator, the output alpha table contains no entries, for every internal node representing an “and” operator, the output alpha table contains all entries from both left and right input alpha tables for the node, and for every internal node representing an “or” operator, the alpha table contains only entries that are contained in both the left and right input alpha tables for the node; and means for creating a data structure containing a listing, for each event, of each node that references the event.

In a sixth embodiment of the present invention, an apparatus for handling an event is provided, the apparatus comprising: means for retrieving an abstract syntax tree associated with a rule containing the event, wherein the abstract syntax tree contains a head internal node having one or more patterns as one child and one or more actions as another child, wherein the one or more patterns are expressed as a sub-tree having the one or more operators as internal nodes and the one or more leaf patterns as leaf nodes; means for, for any leaf patterns that match the event: storing values for each variable referenced by the leaf pattern in an output alpha table; and recursively: passing the output alpha table to a parent node; if the parent node has input alpha tables with enough stored values to evaluate an operator associated with the parent node: evaluating the parent node; storing values from the input alpha tables in a parent output alpha table; and passing the parent output alpha table up to a next parent;

In a seventh embodiment of the present invention, a program storage device readable by a machine and tangibly embodying a program of instructions executable by the machine to perform a method for compiling a rule is provided, the method comprising: receiving the rule, wherein the rule comprises one or more patterns and one or more actions, wherein each of the patterns comprise one or more leaf patterns and one or more operators, wherein each of the leaf patterns reference one or more variables; creating an abstract syntax tree for the rule, wherein the abstract syntax tree contains a head internal node having the one or more patterns as one child and the one or more actions as another child, wherein the one or more patterns are expressed as a sub-tree having the one or more operators as internal nodes and the one or more leaf patterns as leaf nodes; creating an output alpha table for each node of the pattern sub-tree, wherein the output alpha table for a particular node also represents a left or right input alpha table of the particular node's parent, wherein for every leaf node the output alpha table contains entries for each variable to which the leaf node references, for every internal node representing a comparison or “not” operator, the output alpha table contains no entries, for every internal node representing an “and” operator, the output alpha table contains all entries from both left and right input alpha tables for the node, and for every internal node representing an “or” operator, the alpha table contains only entries that are contained in both the left and right input alpha tables for the node; and creating a data structure containing a listing, for each event, of each node that references the event.

In an eighth embodiment of the present invention, a program storage device readable by a machine and tangibly embodying a program of instructions executable by the machine to perform a method for handling an event is provided, the method comprising: retrieving an abstract syntax tree associated with a rule containing the event, wherein the abstract syntax tree contains a head internal node having one or more patterns as one child and one or more actions as another child, wherein the one or more patterns are expressed as a sub-tree having the one or more operators as internal nodes and the one or more leaf patterns as leaf nodes; for any leaf patterns that match the event: storing values for each variable referenced by the leaf pattern in an output alpha table; and recursively: passing the output alpha table to a parent node; if the parent node has input alpha tables with enough stored values to evaluate an operator associated with the parent node: evaluating the parent node; storing values from the input alpha tables in a parent output alpha table; and passing the parent output alpha table up to a next parent.

### BRIEF DESCRIPTION OF THE DRAWINGS

FIG. 1 is a diagram illustrating an example abstract syntax tree in accordance with an embodiment of the present invention.

FIG. 2 is a flow diagram illustrating a method for compiling a rule. This method may be performed by a compiler at the time the rule is being compiled.

FIG. 3 is a flow diagram illustrating a method for handling an event in accordance with an embodiment of the present invention.

FIG. 4 is a block diagram illustrating a compiler in accordance with an embodiment of the present invention.

FIG. 5 is a block diagram illustrating a run-time apparatus in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In an embodiment of the present invention, a pattern-based matching system is applied to rules in an event processing system. A complier takes the rules, which include operators and identifications of events, and parses them into a binary data structure, such as an abstract syntax tree (AST), which contains a description of the major” operators as well as relationships between the objects of the rules. An AST is a formal representation of software syntactical structure. In this data structure, each rule is assigned to a particular node of the tree, with nodes at lower levels being sub-rules of nodes at higher levels.

In an embodiment of the present invention, a new view of the rules is presented. Specifically, an inversion takes place from the old way of thinking. In the old way of thinking, rules were thought of from the rule point of view. When an event occurred, each rule was evaluated in order to determine if the rule was in a condition to fire. Rather than focus on the rule perspective, however, the present invention proposed viewing a rule from an event perspective. In an event perspective, the compiler essentially asks “what rules fire from which events?” Data structures and procedures are then created by the compiler so that they are set up to evaluate at run time to determine which rules to fire based on which event has occurred.

In an embodiment of the present invention, event handlers are used to trigger actions based on events occurring on a data stream. A process of the present invention involves creating the event handler, which may be embodied in, for example, software. The creation of the event handler involves parsing all of the rules in a manner that allows events themselves to trigger actions that will ultimately involve evaluation of rule and, if necessary, firing of those rules.

Each rule fed to the compiler may have two parts: a pattern and an action. The pattern indicates whether or not the rule should fire and the action indicates what should occur if the rule should fire. Therefore, if, for example, the rule is “if event₁ and event₂ then action₁,” then “event₁ and event₂ is the pattern and action₁ is the action.

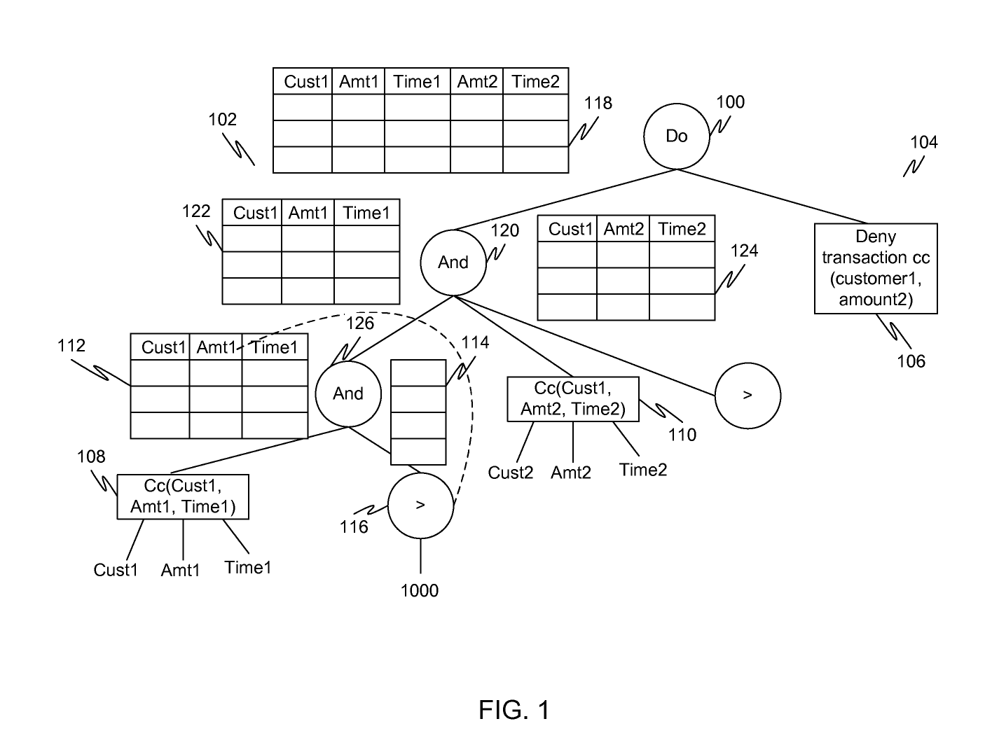

FIG. 1 is a diagram illustrating an example abstract syntax tree in accordance with an embodiment of the present invention. Each rule may have its own abstract syntax tree. Here, the rule may pertain to a credit card transaction. For example, the rule may be “on (cc(customer₁, amount₁, time₁) and amount₁>1000) and cc(customer₁, amount₂, time₂) and amount₂>amount₁ then deny cc(customer₁, amount₂, time₂). Thus, this rule says that if a credit card customer makes a first purchase of greater than a thousand dollars at a first time and then makes a second credit card transaction of greater than the first purchase amount at a second time, the second credit card transaction should be denied.

Each pattern may be considered to be composed of primitive patterns separated by operators. A primitive pattern is a pattern that can be applied to any single event in isolation, and is associated with a set of variables that determine salient aspects of the event. A non-primitive pattern is a combination of other patterns (primitive and non-primitive) “and” operators.

Thus, in the example rule cc(Customer, Amount, Time) is a primitive pattern.

The top node of the tree is a do node 100. On the left side of the do node 100 are patterns 102, while on the right side of the do node 100 are actions 104. Thus, the right side contains a single leaf 106 with the single action of denying the credit card transaction. Each internal node on the pattern 102 side represents an operator. Possible operators include, for example, and, or, not, before, after, greater than, less than, etc. Primitive patterns are represented by leaf patterns 108, 110, which are depicted as leaf nodes on the tree.

In an embodiment of the present invention, during or after constructing the abstract syntax tree, knowledge about events/variables that are going to be reused on another side of an internal; node are used to create alpha tables and alpha table evaluators. Each internal node will have two input alpha tables, a left input alpha table (for example, table 112) and a right input alpha table (for example, table 114). The left input alpha table is a table containing entries for all events/variables that are needed to evaluate the pattern on the left side of the operator, while the right input alpha table is a table containing entries for all events/variables that are needed to evaluate the pattern on the right side of the operator.

Each node then also has an output alpha table. The output alpha table then is the left or right input alpha table of the parent node.

What variables (if any) that are contained in the output alpha table will vary based on the type of the node. Leaf patterns 108, 110 include a variables referenced by the leaf pattern in the output alpha table. Thus, for example, leaf pattern 108 produces output alpha table 112, which contains the variables cust1, amt1, and time1, which are all referenced by the leaf pattern 108.

Nodes based on operators can be split into one of three categories: comparison and “not” operators, “and” operators, and “or” operators. For comparison and “not” operators, no variables are added to the output alpha table. Thus, the comparison operator “>” 116 produces an empty output alpha table 114.

For “and” operators, the variables placed into the output alpha table represent all entries of both the left and the right input alpha tables (i.e., the union of the input alpha tables). Thus, for example, the output alpha table 118 of “and’ operator 120 contains all 5 variables that had been contained in either the left input alpha table 122 or the right input alpha table 124.

For ““or” operators, the variables placed into the output alpha table represent only variables contained in both the left and the right input alpha tables (i.e., the intersection of the input alpha tables). While no “or” operator is shown in FIG. 1, hypothetically if there was an “or” operation between the left input alpha table 122 and the right input alpha table 124, the output alpha table resulting from such an operator would contain only a single variable (cust1) which is shared between the two input tables.

An alpha table evaluator is created for each of the nodes. The alpha table evaluator contains the rules executed based on input alpha tables and/or variables, and produces the output alpha table. The alpha table evaluator also evaluates whether or not the rule is true, and if so, it produces a true condition which is passed to the parent node.

Thus, the result of a true condition in operator node 126 is that the true condition can be passed to node 120. Once all the necessary rules have been evaluated, it is possible that the true condition has been passed all the way up to the do node 100, the top most node in the tree. This node is designed to fire the actions on the right side of the node upon the occurrence of a true condition received on the left side of the node. However, the true condition can be passed in any level of the hierarchy. Thus, the true condition may either trigger an action directly, or may simply trigger one part of another rule that requires another condition to occur. In this way, one alpha table evaluator can trigger another.

Thus, for each rule, the abstract syntax tree, combined with the left and right input alpha tables and the alpha table evaluators, permit much more efficient processing of rules when events are detected, especially in situations where the same event is used in multiple places within a rule.

Events that are evaluated in multiple rules can be handled in various ways. In one embodiment of the present invention, a data structure is maintained identifying, for each possible event, which rules contain the event (i.e., which rules require the event to occur in order for at least one evaluation to take place). Upon detection of an event, an event handler accesses this data structure and retrieves a list of rules that contain the event. At that point, the event handler can invoke handler code for each of the rules (i.e., it can run each rule using the process outlined above).

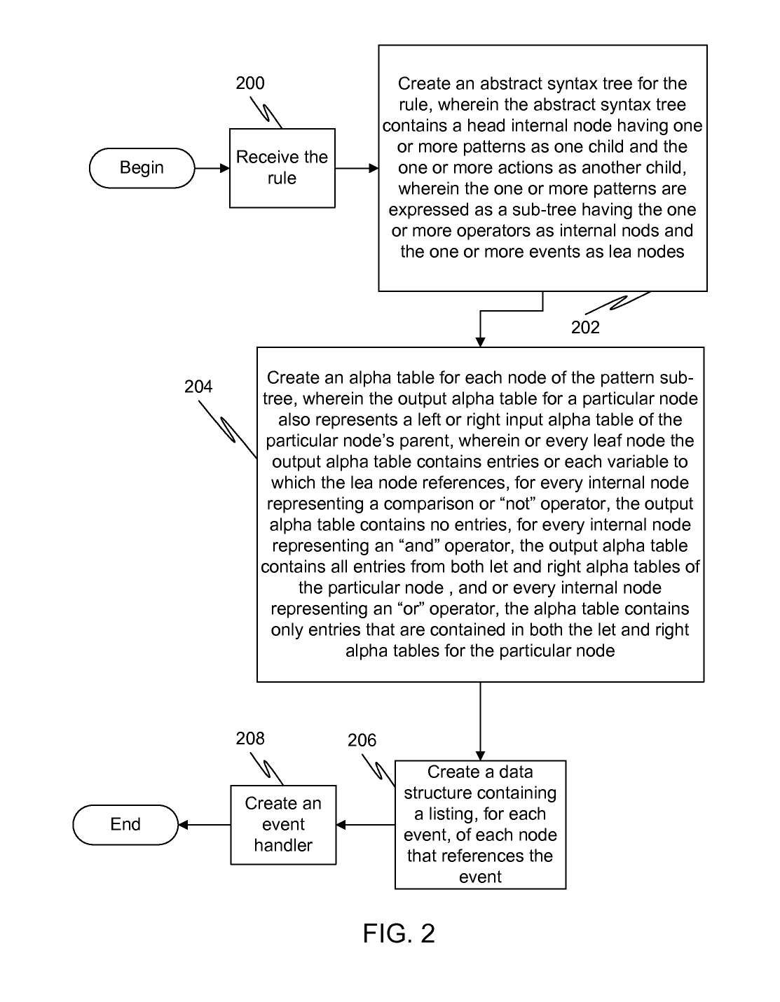

FIG. 2 is a flow diagram illustrating a method for compiling a rule in accordance with an embodiment of the present invention. This method may be performed by a compiler at the time the rule is being compiled. At 200, the rule may be received. The rule itself may comprise one or more patterns and one or more actions, wherein each of the patterns comprise one or more leaf patterns and one or more operators, wherein each of the leaf patterns reference one or more variables.

At 202, an abstract syntax tree is created for the rule, wherein the abstract syntax tree contains a head internal node having the one or more patterns as one child and the one or more actions as another child, wherein the one or more patterns are expressed as a sub-tree having the one or more operators as internal nodes and the one or more events as leaf nodes.

At 204, an output alpha table is created for each node of the pattern sub-tree, wherein the output alpha table for a particular node also represents a left or right input alpha table of the particular node's parent, wherein for every leaf node the output alpha table contains entries for each variable to which the leaf node references, for every internal node representing a comparison or “not” operator, the output alpha table contains no entries, for every internal node representing an “and” operator, the output alpha table contains all entries from both left and right alpha tables for the node, and for every internal node representing an “or” operator, the alpha table contains only entries that are contained in both the left and right alpha tables for the node. At 206, a data structure is created containing a listing, for each event, of each node that references the event.

At 208, an event handler can be created. The event handler is designed to detect an event and retrieve the abstract syntax tree associated with each rule that contains the event. The event handler may be designed to access the listing data structure upon detection of an event and retrieve a list of each rule that contains the event from the special data structure.

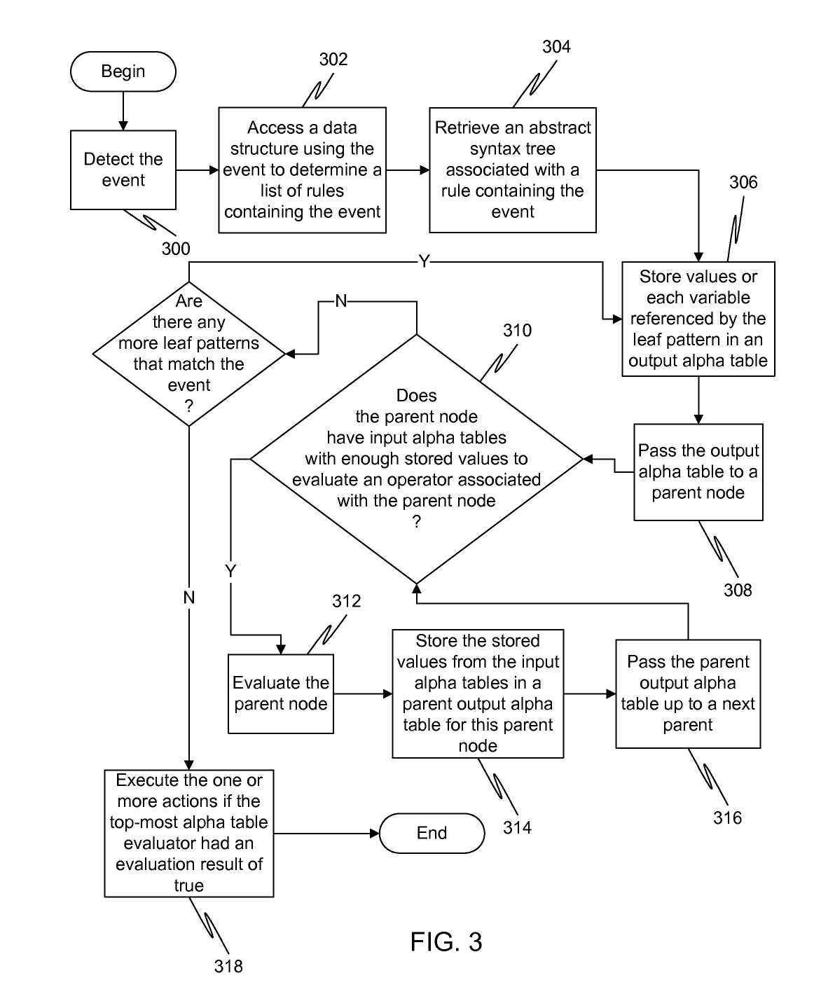

FIG. 2 depicts the steps undertaken by a compiler at runtime. FIG. 3, on the other hand depicts the steps undertaken at runtime, perhaps by an event handler. FIG. 3 is a flow diagram illustrating a method for handling an event in accordance with an embodiment of the present invention. At 300, the event may be detected. At 302, a data structure may be accessed using the event to determine a list of rules containing the event. At 304, an abstract syntax tree associated with a rule containing the event (as indicated by the list of rules) may be retrieved. The abstract syntax tree contains a head internal node having one or more patterns as one child and one or more actions as another child, wherein the one or more patterns are expressed as a sub-tree having the one or more operators as internal nodes and the one or more leaf patterns as leaf nodes. For any leaf patterns that match the event, at 306 values for each variable referenced by the leaf pattern are stored in an output alpha table. Then steps 308-316 are performed recursively. At 308, the output alpha table is passed to a parent node. At 310, it is determined if the parent node has input alpha tables with enough stored values to evaluate an operator associated with the parent node. If so, then at 312 the parent node is evaluated. At 314, the stored values from the input alpha tables are stored in a parent output alpha table for this parent node. Then at 316 the parent output alpha table is passed up a next parent and steps 308-316 are repeated.

The recursive steps may be performed by alpha table evaluators stored at each node. In one embodiment, all of the alpha table evaluators may be run upon detection o an event, if possible. In another embodiment, logic is used to limit the recursive running to only alpha table evaluators corresponding to the internal nodes having the event as a descendant. This saves on processing time, however it requires potentially complex configurations in order to ensure that only particular evaluators are executed.

At 318, once all alpha table evaluators in the pattern sub-tree have been evaluated, the one or more actions may be executed if the top-most alpha table evaluator had an evaluation result of true. In other words, if the top-most alpha table evaluator came back with a “true”, then the rule fires and the actions are executed.

It should be noted that the methods of FIGS. 2 and 3 can be performed in conjunction with each other. In other words, at compile-time, the method of FIG. 2 may be performed, while at run-time, the method of FIG. 3 may be performed. Other embodiments are foreseeable, however, where the methods are these figures are not run in conjunction with each other. For example, at compiler-time the method of FIG. 2 may be performed while a different method may be performed at run-time.

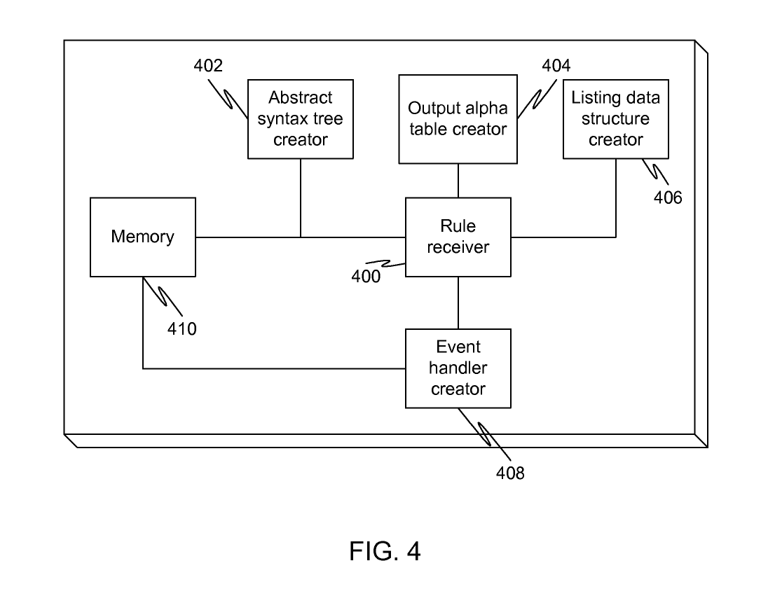

FIG. 4 is a block diagram illustrating a compiler in accordance with an embodiment of the present invention. Each of these components may be implemented in software, hardware, or any combination thereof.

A rule receiver 400 may be configured to receive the rule. An abstract syntax tree creator 402 may be configured to build the abstract syntax tree. This may be performed in the manner described above in FIG. 2 with respect to step 202. An output alpha table creator 404 may be configured to create an output alpha table or each node o the pattern sub-tree. This may be performed in the manner described above in FIG. 2 with respect to step 204. A listing data structure creator 406 may be configured to, create a listing data structure containing a listing, for each event, of each node that references the event. This may be performed in the manner described above in FIG. 2 with respect to step 206.

Additionally, an event handler creator 408 can be coupled to the rule receiver and may be configured to create an event handler for the rule. This may be performed in the manner described above in FIG. 2 with respect to step 208.

Each of the components may additionally be coupled to a memory 410, where the abstract syntax tree may be stored.

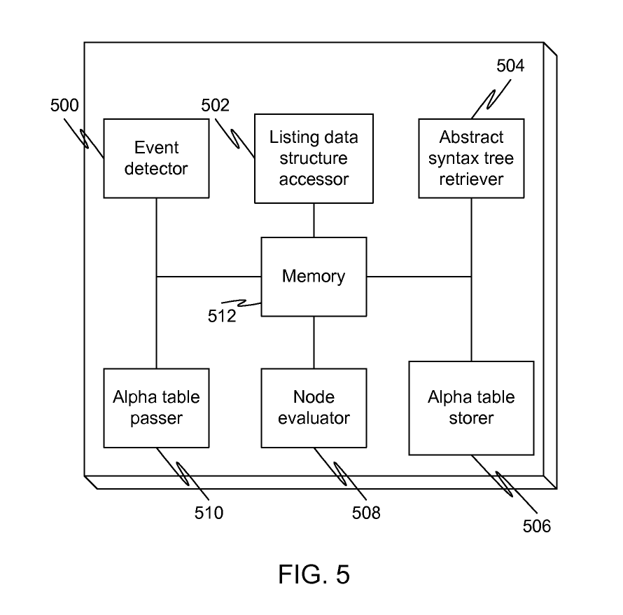

FIG. 5 is a block diagram illustrating a run-time apparatus in accordance with an embodiment of the present invention. Each of these components may be implemented in software, hardware, or any combination thereof. The run-time apparatus may be, for example, an event handler, or a component invoked by an event handler.

An event detector 500 may be configured to detect an event. A listing data structure accessor 502 may be configured to access a data structure using the event to determine a list of rules containing the event. An abstract syntax tree retriever 504 may be configured to retrieve an abstract syntax tree associated with a rule containing the event. This may be performed in the manner described above in FIG. 3 with respect to step 304. An alpha table storer 506 may store values for each variable referenced by any leaf patterns that match the event, in an output alpha table. This may be performed in the manner described above in FIG. 3 with respect to step 306. A node evaluator 508 may evaluate a parent node, if possible. This may be performed in the manner described above in FIG. 3 with respect to step 312. An alpha table passer 510 may then pass the parent output alpha table up to the next parent. This may be performed in the manner described above in FIG. 3 with respect to step 314.

Each of the components may additionally be coupled to a memory 512, where the abstract syntax tree may be stored.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations, or as computer readable code on a computer readable medium for controlling a manufacturing line used to fabricate thermoplastic molded parts. The computer readable medium is defined as any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for compiling a rule, the method comprising:
receiving the rule, wherein the rule comprises one or more patterns and one or more actions, wherein each of the patterns comprise one or more leaf patterns and one or more operators, wherein each of the leaf patterns reference one or more variables;
creating an abstract syntax tree for the rule, wherein the abstract syntax tree contains a head internal node having the one or more patterns as one child and the one or more actions as another child, wherein the one or more patterns are expressed as a sub-tree having the one or more operators as internal nodes and the one or more leaf patterns as leaf nodes;
creating an output alpha table for each node of the pattern sub-tree, wherein the output alpha table for a particular node also represents a left or right input alpha table of the particular node's parent, wherein for every leaf node the output alpha table contains entries for each variable to which the leaf node references, for every internal node representing a comparison or “not” operator, the output alpha table contains no entries, for every internal node representing an “and” operator, the output alpha table contains all entries from both left and right input alpha tables for the node, and for every internal node representing an “or” operator, the alpha table contains only entries that are contained in both the left and right input alpha tables for the node; and
creating a data structure containing a listing, for each event, of each node that references the event.

2. The method of claim 1, further comprising:
creating an alpha table evaluator for each node of the pattern sub-tree. the alpha table evaluator designed to, upon invocation, evaluate the node, examine any referenced variables and left and right input alpha tables, and generate values for a corresponding output alpha table.

3. The method of claim 1, wherein the method is repeated for each rule received at a compiler.

4. The method of claim 1, further comprising:
creating an event handler, wherein the event handler is designed to detect an event and retrieve the abstract syntax tree associated with each rule that contains the event.

5. The method of claim 1, further comprising:
detecting a recent event;
retrieving an abstract syntax tree associated with a rule containing the recent event;
for any leaf nodes of the abstract syntax tree associated with a rule containing the recent event that match the recent event:
evaluating an operator associated with a parent internal node of the leaf node, if possible;
storing a value for the recent event in an alpha table associated with the parent internal node, if the recent event is a leaf node elsewhere in the abstract syntax tree; and
recursively passing the value for the recent event up the abstract syntax tree associated with a rule containing the recent event to store in an alpha table associated with an other parent internal node, if the event is a leaf node that is not a descendant of the other parent internal node;
for each internal node of the abstract syntax tree, associated with a rule containing the recent event, having an associated alpha table evaluator, recursively running an alpha table evaluator associated with the internal node if alpha tables associated with child nodes of the internal node contain values for each event identified by the alpha table evaluator, passing evaluation results from the alpha table evaluators up to higher-level alpha table evaluators; and
once all alpha table evaluators in the abstract syntax tree associated with a rule containing the recent event have been evaluated, executing the one or more actions if the top-most alpha table evaluator had an evaluation result of true.

6. A method for handling an event, comprising:
retrieving an abstract syntax tree associated with a rule containing the event, wherein the abstract syntax tree contains a head internal node having one or more patterns as one child and one or more actions as another child, wherein the one or more patterns are expressed as a sub-tree having the one or more operators as internal nodes and the one or more leaf patterns as leaf nodes;
for any leaf patterns that match the event:
storing values for each variable referenced by the leaf pattern in an output alpha table; and
recursively:
passing the output alpha table to a parent node;
if the parent node has input alpha tables with enough stored values to evaluate an operator associated with the parent node:
evaluating the parent node;
storing values from the input alpha tables in a parent output alpha table; and
passing the parent output alpha table up to a next parent.

7. The method of claim 6, further comprising:
detecting the event;
accessing a data structure using the event to determine a list of rules containing the event; and
wherein the retrieving an abstract syntax tree corresponding to a rule on the list of rules containing the event.

8. The method of claim 6, wherein the method is performed by an event handler.

9. A compiler comprising:
a rule receiver;
an abstract syntax tree creator coupled to the rule receiver and to a memory;
an output alpha table creator coupled to the abstract syntax tree creator and to the memory; and
a listing data structure creator coupled to the rule receiver.

10. The compiler of claim 9, further comprising:
an event handler creator coupled to the rule receiver.

11. An apparatus comprising:
an abstract syntax tree retriever;
a memory coupled to the abstract syntax tree retriever;
an alpha table storer coupled to the memory;
a node evaluator coupled to the memory; and
an alpha table passer coupled to the memory.

12. The apparatus of claim 11, further comprising:
an event detector; and
a listing data structure accessor coupled to the event detector and to the memory.

13. An apparatus for compiling a rule, the apparatus comprising:
means for receiving the rule, wherein the rule comprises one or more patterns and one or more actions, wherein each of the patterns comprise one or more leaf patterns and one or more operators, wherein each of the leaf patterns reference one or more variables;
means for creating an abstract syntax tree for the rule, wherein the abstract syntax tree contains a head internal node having the one or more patterns as one child and the one or more actions as another child, wherein the one or more patterns are expressed as a sub-tree having the one or more operators as internal nodes and the one or more leaf patterns as leaf nodes;
means for creating an output alpha table for each node of the pattern sub-tree, wherein the output alpha table for a particular node also represents a left or right input alpha table of the particular node's parent, wherein for every leaf node the output alpha table contains entries for each variable to which the leaf node references, for every internal node representing a comparison or “not” operator, the output alpha table contains no entries, for every internal node representing an “and” operator, the output alpha table contains all entries from both left and right input alpha tables for the node, and for every internal node representing an “or” operator, the alpha table contains only entries that are contained in both the left and right input alpha tables for the node; and
means for creating a data structure containing a listing, for each event, of each node that references the event.

14. An apparatus for handling an event, the apparatus comprising:
means for retrieving an abstract syntax tree associated with a rule containing the event, wherein the abstract syntax tree contains a head internal node having one or more patterns as one child and one or more actions as another child, wherein the one or more patterns are expressed as a sub-tree having the one or more operators as internal nodes and the one or more leaf patterns as leaf nodes;
means for, for any leaf patterns that match the event:
storing values for each variable referenced by the leaf pattern in an output alpha table; and
recursively:
passing the output alpha table to a parent node;
if the parent node has input alpha tables with enough stored values to evaluate an operator associated with the parent node:
evaluating the parent node;
storing values from the input alpha tables in a parent output alpha table; and
passing the parent output alpha table up to a next parent.

15. A program storage device readable by a machine and tangibly embodying a program of instructions executable by the machine to perform a method for compiling a rule, the method comprising:
receiving the rule, wherein the rule comprises one or more patterns and one or more actions, wherein each of the patterns comprise one or more leaf patterns and one or more operators, wherein each of the leaf patterns reference one or more variables;
creating an abstract syntax tree for the rule, wherein the abstract syntax tree contains a head internal node having the one or more patterns as one child and the one or more actions as another child, wherein the one or more patterns are expressed as a sub-tree having the one or more operators as internal nodes and the one or more leaf patterns as leaf nodes;
creating an output alpha table for each node of the pattern sub-tree, wherein the output alpha table for a particular node also represents a left or right input alpha table of the particular node's parent, wherein for every leaf node the output alpha table contains entries for each variable to which the leaf node references, for every internal node representing a comparison or “not” operator, the output alpha table contains no entries, for every internal node representing an “and” operator, the output alpha table contains all entries from both left and right input alpha tables for the node, and for every internal node representing an “or” operator, the alpha table contains only entries that are contained in both the left and right input alpha tables for the node; and
creating a data structure containing a listing, for each event, of each node that references the event.

16. A program storage device readable by a machine and tangibly embodying a program of instructions executable by the machine to perform a method for handling an event, the method comprising:
retrieving an abstract syntax tree associated with a rule containing the event, wherein the abstract syntax tree contains a head internal node having one or more patterns as one child and one or more actions as another child, wherein the one or more patterns are expressed as a sub-tree having the one or more operators as internal nodes and the one or more leaf patterns as leaf nodes;
for any leaf patterns that match the event:
storing values for each variable referenced by the leaf pattern in an output alpha table; and
recursively:
passing the output alpha table to a parent node;
if the parent node has input alpha tables with enough stored values to evaluate an operator associated with the parent node:
evaluating the parent node;
storing values from the input alpha tables in a parent output alpha table; and
passing the parent output alpha table up to a next parent.
